(19) United States
(12) Patent Application Publication
(10) Pub. No.: US 2013/0338053 A1
(43) Pub. Date: Dec. 19, 2013

(54) Detergent Compositions

(71) Applicant: Jordi Caparros Casco, Barcelona (ES)

(72) Inventor: Jordi Caparros Casco, Barcelona (ES)

(21) Appl. No.: 13/878,263

(22) PCT Filed: Oct. 6, 2011
(86) PCT No.: PCT/ES2011/070697

§ 371 Date: Apr. 18, 2013

(30) Foreign Application Priority Data
Oct. 6, 2010 (ES) P201031477

(51) Int. Cl. C11D 17/00

(52) U.S. Cl. CPC C11D 17/0047
USPC 510/214; 510/478; 510/365; 510/295; 510/238; 510/269; 510/109; 510/446

(57) ABSTRACT

The present invention relates to compacted solid detergent compositions, generally in the form of pills or tablets for all types of cleaning tasks such as cleaning floors and glass, using washing machines, dishwashers, air fresheners, etc. This invention also relates to the use of the detergent composition according to the invention for producing effervescent tablets or compacted powders that can be used in detergent compositions that disaggregate immediately when they come into contact with an aqueous solution.

### OBJECT AND FIELD OF THE INVENTION

The present invention relates to compact solid detergent compositions, generally in the form of pills or tablets for all types of cleaning tasks such as cleaning floors and glass, using washing machines, dishwashers, air fresheners, etc.

The object of the invention is intended for two very specific types of markets: household and industrial. By way of non-limiting example, there are a variety of products in the household sector such as those currently on the market (floor cleaners, rinse aids, disinfectants, descalers, air fresheners, degreasers, soaps and fabric softeners, etc.), which can be used for any type of cleaning in the home. All types of floors (ceramic, earthenware, parquet, etc.), bathrooms (tiles, toilets, sink), kitchens (tiles, countertops, glass-ceramic hobs, taps, extractor fans, aluminium, etc.), clothing (hand or machine washing all types of fabrics either heavily or lightly soiled) can be cleaned. By way of non-limiting example, it is intended for a wide variety of sectors in the industrial market: health, hospitality, industrial, tourism, education, cultural, religious.

This invention also relates to the use of the detergent composition according to the present invention for producing effervescent tablets or compact powders that can be used in detergent compositions that disaggregate immediately when they come into contact with an aqueous solution. The aforementioned disaggregation is characterised in that it dissolves in 30″ and if the aqueous solution has a temperature exceeding 30° C. the time it takes to disaggregate drops significantly to 15″.

### BACKGROUND OF THE INVENTION

Detergent compositions in the form of tablets are known in the state of the art, taking into account that they have several advantages compared to the detergent compositions in liquid form, such as the ease-of-use and manageability, convenient dosage and ease of transport and storage, the stability of the product and savings on packaging.

In addition, it is necessary to highlight environmental significance, as our planet is currently in peril due to pollution, which is why we need products that are the least harmful and contaminating to the environment. As the composition, object of this invention, is in tablet form, this helps not to generate plastic waste, which reduces the volume of debris, which is a major pollutant in our planet, thus helping the environment.

In addition, due to its small size, having to use several means of transport is not necessary, thereby contributing to preventing contamination.

Taking into account that one box of tablets is equivalent to one pallet of cleaning products (degreasers, all-purpose cleaners, disinfectants, etc.), this means that several more vehicles would be required in order to transport the same amount of product; one van carrying tablets is equivalent to six trailers of cleaning products.

In addition, as it is available in single-use packs, the quantity used is always the same, making it possible to control consumption and helping to prevent excess and waste; and if there is no waste, there is less pollution.

As it is small in size it is easy to transport, thereby avoiding physical loads and the potential for injury. It is not the same transporting several bottles that contain various cleaning products that could weigh several tonnes, than it is to transport several tablets that are easily handled.

Due to these advantages, the detergent compositions in compact form are becoming an increasingly larger share of the market among consumers of detergent products, both at an industrial and household level.

The detergent tablets are normally made by previously mixing the components and forming the latter into a tablet by using a tablet press and by compressing the components. However, the processes of compressing traditional tablets have significant drawbacks including, but not limited to, the fact that the selected components of a detergent composition can be adversely affected by the compression pressure in the tablet press, which then do not disaggregate properly.

To avoid these drawbacks, attempts have been made to separate the components of the detergent composition in the detergent tablets of the prior art that can potentially react with each other when the detergent composition is compressed in tablet form.

Components have been separated, for example, in the international patent application WO9927063, by preparing multi-layer tablets, in which the reactive components are contained in different layers of the tablet or by encapsulating and coating the reactive components. These multi-layer tablets of the prior art are traditionally made by using multiple stages of compression. Therefore, the layers of the tablet that are subjected to more than one stage of compression can be subjected to a total cumulative and possibly greater compression pressure.

In addition, it is known that an increase in the compression pressure of the tablet press decreases the rate of dissolution of the tablet, such that these multi-layer tablets may not dissolve in a satisfactory manner when used. There is also no significant difference in the dissolution rates of multi-layer tablets. Another alternative is that the detergent tablets comprise a compressed solid body portion having at least one mould in that portion of compressed solid body; and at least one non-compressed portion mounted on the mould of that compressed solid body portion, as in the aforementioned international patent application WO9927063.

There are more documents of the prior art that protect different detergent compositions such as the European patent application EP839906 that describes tablets of a detergent composition in the form of compacted particles, for washing fabrics, in which the tablet comprises particles containing partially hydrated sodium tripolyphosphate in order for it to contain water of hydration in an amount from 1% to 5% by weight of the sodium tripolyphosphate in those particles so they disaggregate quickly when they are used.

These tablets will normally contain powder particles as a base that incorporate an active organic surfactant as a detergent together with an adjuvant for detergency, as well as particles of other ingredients, such as bleaching compounds like sodium percarbonate. However, these detergent tablets are affected by the limitation of manufacturing and large-scale costs, since the procedure for obtaining the tablets is much more complex.

For this reason, despite having been on the market for several years, detergents in tablet form have not achieved a significant market share, despite the many advantages, especially in respect of how convenient they are to use: they are easily dispensed, take up little space and it is easy to know how many doses are left. One of the requirements for formulating a detergent in tablet form is that it disintegrates quickly when it comes into contact with wash water.

In this sense, the composition of the tablets finally obtained, object of the invention herein, should have proper mechanical resistance when they are dry, before being used, and nonetheless should break up and disperse/dissolve quickly when they are added to the wash water. It has not been shown that both properties can be easily and simultaneously achieved. As more pressure is used when a tablet is compacted, the tablet density and resistance are increased but the disaggregation/dissolution rate decreases when the tablet comes into contact with the wash water.

Therefore, there is still a need for improved detergent tablets that can release active detergent ingredients in a process of household and industrial washing that break up at an adequate speed and immediately release active detergent compounds when they come into contact with an aqueous phase, thereby providing better performance.

To resolve the limitation of the process of disaggregation/compaction, the inventors of the invention herein have developed different effervescent detergent compositions comprising a chemically effective amount of at least 20% to 30% of sodium lauryl sulphate and 20% to 30% of citric acid and sodium carbonate. This allows for optimal disaggregation and release of the active detergent load and ease of preparation by compaction processes known in the prior art. One of the most characteristic advantages of the invention herein is that dilution is improved in respect of what is currently available on the market, so it is a more effective alternative both for household and industrial use.

### DESCRIPTION OF THE INVENTION

The invention herein has been developed to provide effervescent detergent compositions comprising a chemically effective amount of at least 20% to 30% of sodium lauryl sulphate and 20% to 30% citric acid and sodium carbonate. This allows for optimal disaggregation and release of the active detergent load and ease of preparation by compaction processes known in the state of the art.

In a preferred form, a composition for this invention is the following composition for mopping floors:

| COMPONENT | WEIGHT % |
|---|---|
| Citric acid | >25% |
| Sodium bicarbonate | 5-15% |
| Sodium lauryl sulphate | >25% |
| Dye and perfume | 0.01%-0.3% |

Total weight of the compressed composition: 3 g*
*Preservative (only for tablets exceeding 10 g to be pre-dissolved in a 1 litre, 5 litre, 10 litre or up to 20 litre bottle.)

According to the object of this invention, the individual values of the percentages of the various components of the detergent composition are such that the total of the composition never exceeds 100%.

According to the present invention the components of the composition herein are selected from the group consisting of: sodium bicarbonate, sodium carbonate, citric acid, ammonium bicarbonate, sodium lauryl sulphate, perfume (essence), dye, sodium chloride, sodium sulphonate naphthalene formaldehyde, sodium hypochlorite granular, nitrilotriacetic acid, sodium hydroxide, potassium hydroxide, sodium dodecylbenzenesulphanate, microcrystalline cellulose, magnesium stearate, sodium nitrite, sodium xylene sulphonate, tetradecyl dimethyl benzyl ammonium chloride, disinfectant, quaternary ammoniums, sodium benzoate, sodium gluconate, hydroxymethyl cellulose, nitrilotriacetic acid trisodium salt, pure guar gum, N-hydroxyethylenediamine triacetic acid trisodium salt, urea and sodium sulphate.

According to a preferred embodiment, the adjuvant is an effervescent disaggregating agent and is a material that has high solubility in water.

According to a preferred aspect, the composition is available in single-dose or single-use format, either as a pill or a tablet.

According to an important aspect of the invention, the composition has the advantage that it disaggregates when it comes into contact with an aqueous solution at intervals of between 15″ and 30″ and if the aqueous solution has a temperature exceeding 30° C. the time it takes to disaggregate is 15″.

For the purpose of the present invention, the composition is used in a 1:10 weight ratio of solid composition per volume of water; such that 1 gram of composition will be used per 10 litres of water, 5 grams of composition per 50 litres of water, 10 grams of composition per 100 litres of water or 20 grams of composition per 200 litres of water.

Advantageously, the composition of this invention includes the property for obtaining more rapid dissolution, a greater concentration of surfactants, higher-performance products, product range thanks to the technique of compaction and the concentration of raw materials.

One of the advantageous characteristics of the invention herein is that, although there are currently countless products in the form of tablets for use as detergents on the market, none can span the two sectors that make up the cleaning industry in general or include disinfection as achieved in the composition according to this invention.

The characteristic essence of the composition object of this invention is that it dilutes at intervals of between 15″ and 30″ regardless of the amount of detergent it is intended to be used.

This characteristic is possible thanks to the composition comprising an active compound as detergent, an adjuvant, and a chemically effective amount of at least 20% to 30% of sodium lauryl sulphate and 20% to 30% of citric acid and sodium carbonate.

According to another important aspect, the invention herein relates to the use of the composition of this invention to produce tablets or solid compacted compositions for use as effervescent detergent compositions.

In accordance with another important aspect, the invention herein relates to the use of the composition for the household and industrial sector as a detergent selected from the group consisting of floor cleaners, polishes, disinfectants, descalers, air fresheners, degreasers, soaps and fabric softeners, which can be used for ceramic, earthenware, parquet, metal, wood, glass-ceramic hobs and glass surfaces.

According to another aspect, the invention herein relates to the use of the detergent composition for washing fabrics both for hand and machine washing.

According to another aspect, the invention herein relates to use in a 1:10 weight ratio of solid composition per volume of water.

### DESCRIPTION OF A PREFERRED EMBODIMENT

The preferred embodiment that follows hereinbelow is provided for illustrative but not limitative purposes, to provide a better understanding of the invention.

The manufacturing process includes the stages of grinding the components of the following preferred composition, by means of a milling system (similar to a coffee grinder):

| COMPONENT | WEIGHT % |
|---|---|
| Citric acid | >25% |
| Sodium bicarbonate | 5-15% |
| Sodium lauryl sulphate | >25% |
| Dye and perfume | 0.01%-0.3% |

Total weight of the compressed composition: 3 g*
*Preservative (only for tablets exceeding 10 g to be pre-dissolved in a 1 litre, 5 litre, 10 litre or up to 20 litre bottle.)

Once the mixture has been ground, all the components are well mixed together. The second step involves the press (similar to the one that is used for aspirin tablets). This press exerts a pressure of 10 tonnes per cm², which is how the tablets are compacted and how the hardness of the tablets is increased, thereby improving their friability. The last step is the packaging process, either in blister format and/or packs or product packaging systems in plastic sleeves or flow packed, depending on the size, product composition and the sector, either industrial or household, that it is intended for.

1. A detergent composition in the form of compacted particles or powder, characterised in that it comprises an active compound as detergent, an adjuvant, and a chemically effective amount of at least 20% to 30% of sodium lauryl sulphate and 20% to 30% of citric acid and sodium carbonate.

2. A detergent composition in the form of compacted particles or powder according to claim 1, characterised in that the adjuvant is an effervescent disaggregating agent.

3. A detergent composition in the form of compacted particles or powder according to claim 2, characterised in that the disaggregating agent is a material that has high solubility in water.

4. A detergent composition in the form of compacted particles or powder according to any of the claims 1 to 3, characterised in that it comprises the following components:

| COMPONENT | WEIGHT % |
|---|---|
| Citric acid | >25% |
| Sodium bicarbonate | 5-15% |
| Sodium lauryl sulphate | >25% |
| Dye and perfume | 0.01%-0.3% |

5. A detergent composition in the form of compacted particles or powder according to any of the claims 1 to 4, characterised in that it is available in single-dose or single-use format.

6. A detergent composition in the form of compacted particles or powder according to claim 5, characterised in that it is a tablet.

7. A detergent composition in the form of compacted particles or powder according to any of the claims 1 to 6, characterised in that it disaggregates when it comes into contact with an aqueous solution at intervals of between 15″ and 30″.

8. A detergent composition in the form of compacted particles or powder according to claim 7, characterised in that if the aqueous solution is a temperature exceeding 30° C., the time it takes to disaggregate is 15″.

9. Use of the composition of any of the claims 1 to 8, to manufacture solid compacted compositions that can be used as effervescent detergent compositions.

10. Use of the composition of any of the claims 1 to 8, for the household and industrial sector.

11. Use of the composition of any of the claims 1 to 8, as a detergent selected from the group consisting of floor cleaners, rinse aids, disinfectants, descalers, air fresheners, degreasers, soaps and fabric softeners.

12. Use of the composition of any of the claims 1 to 8, on ceramic, earthenware, parquet, metal, wood, glass-ceramic hobs and glass surfaces.

13. Use of the composition of any of the claims 1 to 8, for washing fabrics both for hand and machine washing.

14. Use of the composition of any of the claims 1 to 8, in a 1:10 weight ratio of solid composition per volume of water.
